(19) United States
(12) Patent Application Publication
(10) Pub. No.: US 2025/0299082 A1
(43) Pub. Date: Sep. 25, 2025

(54) SYSTEMS AND METHODS FOR SCALABLE QUANTUM COMPUTATION

(71) Applicant: Universal Quantum LTD, Brighton (GB)

(72) Inventor: Peter BRADBEER, Brighton (GB)

(21) Appl. No.: 19/182,518

(22) Filed: Apr. 17, 2025

Related U.S. Application Data
(63) Continuation of application No. PCT/GB2023/052773, filed on Oct. 23, 2023.

(30) Foreign Application Priority Data
Oct. 21, 2022 (GB) 2215637.6

(51) Int. Cl. G06N 10/40

(52) U.S. Cl. CPC G06N 10/40

(57) ABSTRACT

Disclosed herein is a method of manufacturing an array of quantum computer modules, each module comprising at least a qubit gate, the method comprising: providing a top plate; providing a plurality of supports for each module, each support having a proximal end and a distal end; providing an engineering surface plate; adhering the proximal ends of the supports to the top plate using a conformal affixent; bringing the engineering surface plate into contact with all of the distal ends of the supports while the conformal affixent cures; removing the engineering surface plate after the affixent has cured; and fixing the modules to the distal ends of the supports.

### CROSS-REFERENCE

This application is a continuation of International Application No. PCT/GB2023/052773, filed on Oct. 23, 2023, which claims the benefit of United Kingdom (GB) Patent Application No. 2215637.6, filed on Oct. 21, 2022, each of which are incorporated herein in their entirety by reference.

### BACKGROUND OF THE INVENTION

The present invention relates to providing a scalable system for DACs for an ion trap quantum computer. Quantum computing in general, unlike so-called “classical computing”, relies on the quantum mechanical properties of particles or matter to produce or alter data. The data may be represented by quantum bits or “qubits”, which is a two state quantum mechanical system. Unlike classical computing, the qubit may be in superposition of quantum states. Another feature of quantum computing is the entanglement between qubits in which the state of one particle or atom is influenced by another particle or atom. Quantum mechanical qubits are able to encode information as combinations of zeros and ones simultaneously. Such properties open numerous complex numerical applications that are traditionally difficult for classical computers. Examples include artificial Intelligence, image processing and recognition, cryptography, or secure communications and so on. Within an ion hyperfine electronic states (Zeeman split states) can be revealed by the use of a magnetic field and the different electron levels used as the different qubit states and electrons moved between the levels using microwave radiation or lasers.

### SUMMARY OF THE INVENTION

In an aspect disclosed herein is a method of manufacturing an array of quantum computer modules, each module comprising at least a qubit gate, the method comprising: providing a top plate; providing a plurality of supports for each module, each support having a proximal end and a distal end; providing an engineering surface plate; adhering the proximal ends of the supports to the top plate using a conformal affixent; bringing the engineering surface plate into contact with all of the distal ends of the supports while the conformal affixent cures; removing the engineering surface plate after the affixent has cured; and fixing the modules to the distal ends of the supports.

In some embodiments, bringing the engineering surface plate into contact with all of the distal ends of the supports comprises applying a predetermined force to the engineering surface plate towards the plurality of supports. In some embodiments, the method further comprises: measuring, while the engineering surface plate is in contact with the distal ends of the supports and the conformal affixent is curing, the strain on the top plate in a first direction within the plane of the top plate and in a second direction, perpendicular to the first direction and within the plane of the top plate to obtain normalised strain values; subjecting, while the quantum computer is operating, the top plate to the normalised strain in the first direction and the normalised strain in the second direction. In some embodiments, measuring the strain comprises using a strain gauge. In some embodiments, measuring the strain comprises using a planometer. In some embodiments, the strain is measured in a plurality of positions on the top plate. In some embodiments, the method comprises subjecting, while the quantum computer is operating, the top plate to the normalised strain in the first direction and the normalised strain in the second direction comprises: measuring the strain on the top plate in the first and second directions; and if the strain is not within a predetermined range of the normalised strain values, applying one or more forces until the strain is within a predetermined range of the normalised strain values. In some embodiments, the top plate and the supports have a differential coefficient of thermal expansion of less than 4 ppm. In some embodiments, the supports and the modules have a differential coefficient of thermal expansion of less than 4 ppm. In some embodiments, the top plate and the conformal affixent have a differential coefficient of thermal expansion of less than 4 ppm. In some embodiments, the top plate, the conformal affixent, the supports and the modules all have coefficients of thermal expansion within 4 ppm of each other. In some embodiments, the cement applied between the supports and the top plate has a thickness of less than 200 μm prior to the engineering surface plate being brought into contact with the supports. In some embodiments, fixing the modules to the distal ends of the supports comprises applying a force to the modules against the supports. In some embodiments, the plurality of supports comprise a grid arrangement of joists defining a two dimensional array of quadrilaterals, each joist having a plurality of through holes between the quadrilaterals. In some embodiments, the top plate substantially comprises Molybdenum. In some embodiments, the conformal affixent is a ceramic cement. In some embodiments, the ceramic cement comprises magnesium oxide. In some embodiments, the method further comprises: providing a plurality of thermocouples, each coupled to the top plate at a different temperature measurement position; providing a plurality of thermopads, each coupled to the top plate at a different position; measuring, using the thermocouples, the temperatures at the plurality of temperature measurement positions; and operating one or more of the thermocouples so that the top plate is constant across the top plate.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts an array of modules in a quantum computer;

FIG. 2 depicts a cross section of a portion of a quantum computer according to the invention;

FIG. 3 depicts a method according to the invention;

FIG. 4 depicts a step of the invention;

FIG. 5A depicts an arrangement of joists;

FIG. 5B depicts a cross section of a joist;

FIG. 6 depicts and alternative method according to the invention; and

FIG. 7 depicts a top plate.

### DETAILED DESCRIPTION OF THE INVENTION

In ion trap quantum computers (quantum charged coupled devices) ion traps can be used to control ions used in quantum computation and surface electrodes are used to generate electric fields to manipulate and trap the ions suspended in free space. The surface electrode potentials of an ion-trap are in turn controlled by DACs. State-of-the-art quantum computers use many DACs of the same type, for example 16 bit DACs with a better than 1 MHz update rate.

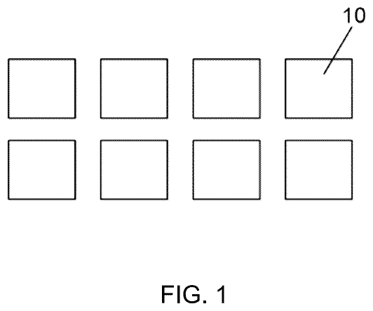

On a single chip, or module, there are a plurality of quantum gates. For example, on a module of size 300×300 mm there may be 4096 gate zones. However, there is a limit to the size of individual modules which can be easily manufactured. One solution is therefore to create an array of modules, as depicted in FIG. 1, with a few micrometers of spacing between each module. Ions, or qubits, can be transferred between the different modules as necessary and therefore significantly larger computers can be developed. For example, a 10×10 array of modules, may have a 409,600 different gate zones.

However the disadvantage of any array of chips, or modules, is that any misalignment, either laterally or in height can generate errors across the whole quantum computers and therefore prevent the operation of the device.

The present solution is to include at least one piezoelectric actuator for each module. There may be at least three piezoelectric actuators in order to adjust the position in the x, y, and z directions. Indeed there may be two or more piezoelectric actuators for each direction to correct for twist. In addition to the plurality of piezoelectric actuators for each module there are also detectors to detect the position of each module in the x, y and z directions.

Thus, the present solution requires a very large number of both detectors and actuators and an error in any one of the detectors or actuators can result in the operation of the entire device becoming inhibited. There is therefore a significant risk to the operation of the device if even one of the actuators or detectors malfunctions.

Furthermore, the inclusion of a plurality of actuators and a plurality of detectors for each module occupies a large volume of space which could be better used for other purposes. Additionally, data from the many sensors and actuators must be transmitted into and out of the clean quantum environment and space at the perimeter of the device may be limited. The space occupied by the actuators, detectors and data lines can therefore limit the overall size of the device.

It is therefore desirable to generate a simple way of ensuring that all modules within an arrangement are flat. It is an aim of the invention to provide a method of manufacturing a scalable system in which transfer of ions between modules is seamless as the modules are all flat and level with each other.

According to the invention there is therefore provided a method of manufacturing a quantum computer comprising a plurality of modules, each module comprising at least a qubit gate, the method comprising providing a top plate, providing a plurality of supports for each module, each support having a proximal end and a distal end, providing an engineering surface plate, adhering the proximal ends of the supports to the top plate using a conformal affixent, bringing the engineering surface plate into contact with all of the distal ends of the supports while the conformal affixent cures, removing the engineering surface plate after the affixent has cured and fixing the modules to the distal ends of the supports.

The engineering surface plate comprises a very flat surface and by bringing the engineering plate into contact with the distal ends of the supports while the conformal affixent cures the distal ends of the supports will all be flat. The modules are held and supported by the distal ends of the supports. Thus, if the distal ends of the supports are flat then the modules are held in a flat position.

The engineering surface plate may be of metrology grade 00. It should have a flatness of less than 10 μm, preferably less than 5 μm and most preferably less than 2 μm. The present method of manufacturing provides a simple way of ensuring that all the modules are flat. Furthermore, with the proposed arrangement each module does not need an actuator or detector and so the arrangement is therefore very scalable.

The engineering plate should be in contact with the distal ends of all the supports. As such, bringing the engineering surface plate into contact with all of the distal ends of the supports may comprise applying a predetermined force to the engineering surface plate towards the plurality of supports.

The method may further comprise, while the engineering surface plate is in contact with the distal ends of the supports and the conformal affixent is curing, measuring the strain on the top plate in a first direction within the plane of the top plate and in a second direction, perpendicular to the first direction and within the plane of the top plate to obtain normalised strain values. By measuring the strain it is possible to evaluate the strain to which the top plate is subjected during the process of ensuring the distal ends of the supports are flat.

When the quantum computer is operating, the top plate should be subjected to the normalised strain in the first direction and the measured strain in the second direction. The strain may be measured using a strain gauge within, or on top of the top plate. Alternatively it may be measured using a planometer. The strain is preferably measured at a plurality of non-linear positions on the top plate.

Subjecting the top plate to the normalised strain in the first direction and the normalised strain in the second direction while the quantum computer is operating may comprise measuring the strain on the top plate in the first and second directions. If the strain is not within a predetermined range of the normalised strain values, applying one or more forces until the strain is within a predetermined range of the normalised strain values. The predetermined range may be within ±5% of the normalised strain values.

To avoid strains being induced due to thermal expansion and contraction the different elements of the device should preferably have very similar coefficients of thermal expansion. In particular the top plate and the supports preferably have a differential coefficient of thermal expansion of less than 4 ppm. Preferably, the supports and the modules have a differential coefficient of thermal expansion of less than 4 ppm. Preferably the top plate, the supports and the modules all have differential coefficients of thermal expansion of within 4 ppm of each other. By having similar coefficients of thermal expansion shear forces due to differing rates of expansion or contraction are minimised. The coefficients of thermal expansion are preferably below 8 ppm/K and therefore there is preferably minimal expansion and contraction. In particular the differential coefficients of thermal expansion are less than 4 ppm. By having similar coefficients of thermal expansion twist and shear forces are minimized.

For optimal results the engineering surface plate preferably has a flatness of less than 3 μm. The engineering surface plate may be made of granite or glass. The top plate is preferably substantially flat and has a flatness of less than 50 μm.

The cement applied between the supports and the top plate preferably has a thickness of less than 200 μm, or preferably less than 50 μm prior to the engineering surface plate being brought into contact with the supports.

Fixing the modules to the distal ends of the support may comprise applying a force to the modules against the supports. This brings the module into continuous contact with the support and flattens out any residual bow and twist. The force applied may preferably be the same as the force applied to the engineering surface towards the supports as there will then be the same forces applied to the supports and top plates.

A method according to any one of the preceding claims wherein the plurality of supports comprise a grid arrangement of joists defining a two dimensional array of quadrilaterals, each joist having a plurality of through holes between the quadrilaterals.

The top plate is preferably made of Molybdenum as this has a low coefficient of thermal expansion. An alternative material for the top plate could be Titanium. Another alternative is a laminate surface comprising copper, Molybdenum and a further copper layer. The Mo layer is generally thicker compared to the copper and so the coefficient of thermal expansion is low. Any material have a coefficient of thermal expansion of less than 8 ppm/K. The conformal affixent is preferably a ceramic cement.

Referring to FIG. 1, there is an example arrangement of a plurality of modules 10 within a quantum computer. The module comprises a plurality of electrodes to which voltages can be applied to form a potential well to trap an ion. By adjusting the voltages on the electrodes the potential well can be moved to move the ion so it is positioned above different portions of the module.

The module may be divided into different portions with some portions forming gates zones where specific gate operations may be performed. Using the potential well an ion can be moved to different gate zones so that different gate functions can be performed.

The ion may be transported between modules by applying appropriate voltages to the electrodes at the perimeter of adjacent modules 10. As such adjacent modules must be accurately aligned. In particular adjacent modules must be at the same height.

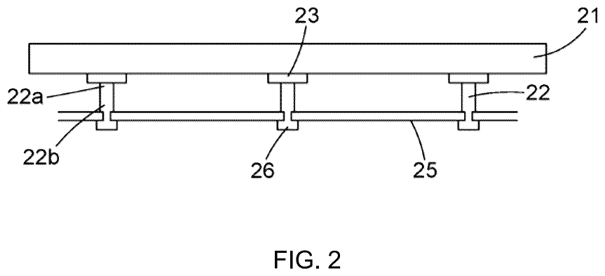

A cross section of an arrangement manufactured according to the invention is depicted in FIG. 2. There is a top plate 21 and attached to the top plate are a plurality of supports 22. The proximal end 22a of the supports are attached to the top plate using cement. The cement is a conformal cement and thus allows bondline thickness to vary between different supports. Each module 10 is supported by a plurality of supports and attached thereto by a fixing 26.

According to the invention the distal ends 22b of the supports are flat such that the modules attached thereto will also be flat. This is achieved by the method described below.

The top plate 21 is preferably substantially flat. For example it may be flat to within 50 um. In one embodiment the top plate is made of Molybdenum as this can be manufactured to a sufficient degree of flatness. Additionally, it has a low coefficient of thermal expansion also has a similar coefficient of thermal expansion to Silicon and glass, out of which the modules are made.

The supports are preferably made from a metal which has a similar thermal coefficient of expansion to Molybdenum. Indeed they may also be made from Molybdenum.

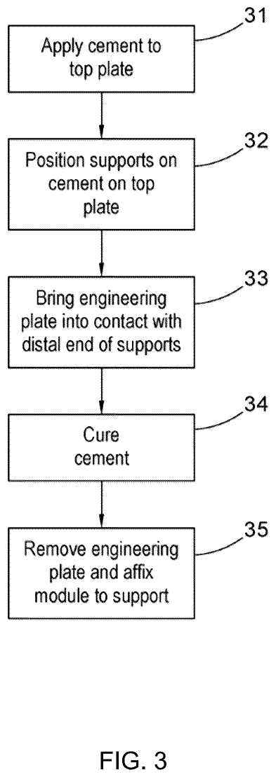

The process of the invention is depicted in FIG. 3. According to the invention the supports cement is applied 31 to the top plate in the location of the supports, and the supports are attached thereto 32. The supports themselves are very flat, for example to within ±5 um. The cement may be, for example, a ceramic cement or an epoxy cement. As quantum computers are generally operated at less than 100° K the cement used must be able to withstand temperatures below 100° K. The thickness of the cement applied is less than 200 μm. It may be in the range 20 μm to 100 μm and preferably approximately 50 μm.

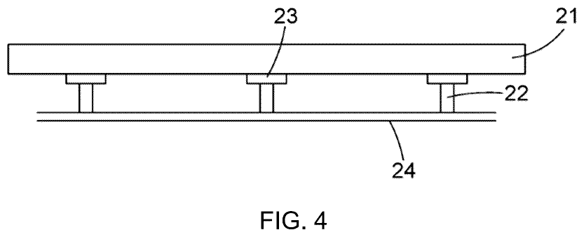

At step 33 an engineering plate 24 is then brought into contact with the distal ends of the supports 22b and this is depicted in FIG. 4. The engineering surface plate is preferably grade 00. It should preferably have a flatness of less than 10 μm, preferably less than 5 μm and most preferably less than 2 μm and the engineering plate may be made of granite or glass. A force may be applied to the engineering plate. The stress on the supports may be less than 50 KN/m². In this way the distal ends of the supports will become flat. As this occurs before the cement has cured and is therefore still flexible the thickness of the cement may reduce in some areas so that the distal ends of the supports are flat. The engineering plate is held in position during the curing of the cement until the cement is fully cured such that the cement cures with the distal ends 22b of the supports flat.

Once the cement has cured the engineering plate 24 is removed and the modules 10 can be attached to the supports using fixings 26. The modules are therefore fixed to supports which form a plane to the same flatness as the engineering plate. Thus, if the engineering plate 24 has a flatness of 3 μm the flatness across the modules will also be 3 μm. This provides an extremely simple way of manufacturing a system with a plurality of modules arranged to form a very flat surface.

The thickness of cement 23 under each support may not be the same as the thickness of the cement is used to compensate for any discrepancies in the flatness of the top plate and the depth of the supports. Thus, the cement may have a thickness of 45 um at some points and have a thickness of 35 μm at other points. As described above, the cement is conformal. Furthermore, when the cement sets there should be minimal bond line thickness change. The cement preferably has a similar coefficient of thermal expansion to the top plate and also the supports. Preferably, the coefficient of thermal expansion is low, in particular less than 12 ppm/K Thus, it will expand at a similar rate to the top plate and the supports.

The apparatus is often baked at a high temperature to remove any contaminants. Thus, the cement used must be able to withstand high temperatures without any structural variations. Ceramic cements have been found to be suitable, particularly those comprising Magnesium oxide. Ceramic cements comprising Magnesium oxide have a low coefficient of thermal expansion which is also similar to that of Molybdenum.

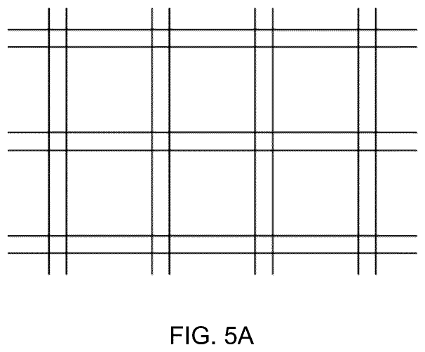

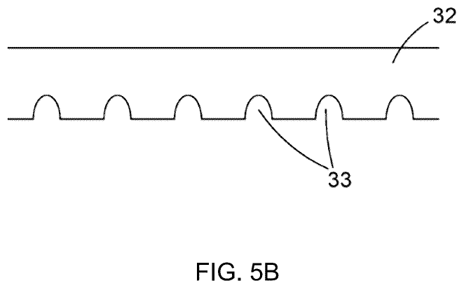

FIG. 5A depicts a plan view of an arrangement of joists 32 which form supports as described above. The joists may be made of the same material as the top plate. For example, they may be made of Titanium or alternatively Molybdenum (possibly with laminated copper). An alternative material for the apparatus is Sapphire. As can be seen the joists form a grid such that each module fits within a square of the grid. This provides an optimal way of supporting the modules such that they are substantially supported along the perimeter. FIG. 5B depicts a cross section of a joist 32 depicted in FIG. 5A. As can be seen, the joist as a plurality of holes 33, or arches. These are to allow the ions to pass through to adjacent modules when the joists 32 are supporting modules. Although the holes 33 are depicted as arches they could equally be holes within the body of the joist.

As the quantum modules are generally operated at less than 100° K there may be some thermal contraction. Thus, the top plate, the supports and the modules should all have similar thermal expansion coefficients to ensure that different rates of expansion and contraction do not cause strains and thus the array of modules to become less flat. The top plate, the joists and the modules should preferably have thermal expansion coefficients within 5% of each other.

As will be appreciated, the aim of the invention is to ensure flatness across an array of modules. However, if, during operation, the arrangement is subjected to difference forces and strains then the array of modules will no longer be as flat. According to an embodiment of the invention the strain within the top plate is measured. During operation of the quantum modules the top plate can be subject to the same forces and strains to ensure that the array of modules is similarly flat.

The strain can be measured using one or more strain gauges within, or attached to the top plate. The strain is measured in a first direction within the plane of the top plate 21 and also in a second direction, perpendicular to the first direction and within the plane of the top plate. For more accurate results the strain (in the two perpendicular directions) should be measured at a plurality of different, non-linear, positions on the top plate as the strain may be different at different positions.

An alternative way to measure the strain is to use a planometer. This uses measures the angle of a surface and therefore, if the surface is under strain and therefore at a slightly different angle this will be detected. The angle of different positions on the surface can be detected using a planometer and then during, operation the same positions on the surface detected and, if necessary, forces applied to ensure that the top plate has the same surface shape as it did while the engineering surface plate was applied and the cement cured.

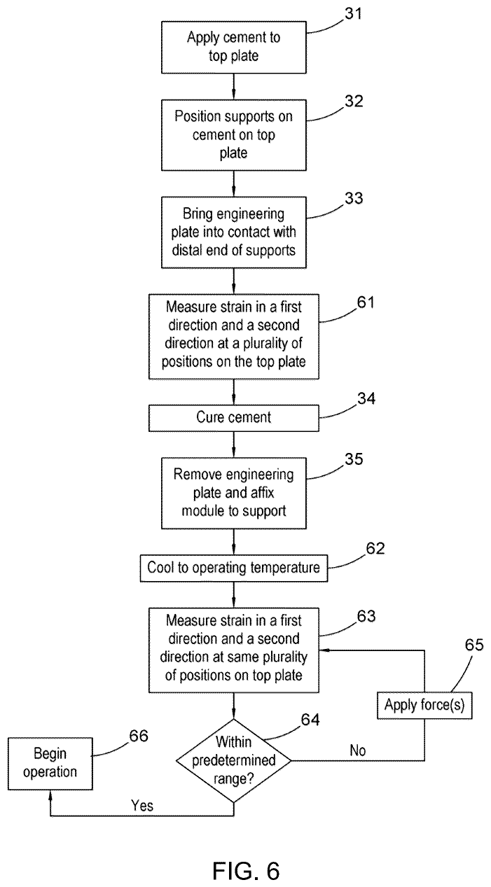

FIG. 6 depicts a method of ensuring that the strains during operation are similar to those during the assembly. Some of the steps are similar to those depicted in FIG. 3 and those will not be described in detail again. Once the engineering plate 24 is in contact with the distal end of the supports the strain is measured 61 in a first direction and a second, perpendicular direction, both within the plane of the top plate. The strain is measured in both directions at a plurality of predetermined positions on the top plate. Although the strain measurement and the cement curing are depicted as sequential they are contemporaneous. Similarly, the engineering plate remains in contact with the distal ends 22b of the supports.

The device is assembled by affixing the modules. It may also be placed in a support or a clean environment. Once the device is assembled it is cooled to the operating temperature 62. In this example it is cooled to 50° K. Optimally it may also be placed in operating conditions such as a low pressure environment, for example 10⁻³ Torr. Once the temperature has reached operating temperature the strain is measured 63 in the first and second directions at the plurality of predetermined positions on the top plate 21.

The strain needs to be within a predetermined range of the originally measured strain values 64. If the strain is not within a predetermined range force(s) are applied and the strain again measured. This is repeated until the strain is within a predetermined range of the originally measured strain values. One the strain values are with a predetermined range of the originally measured strain values operation of the device may commence.

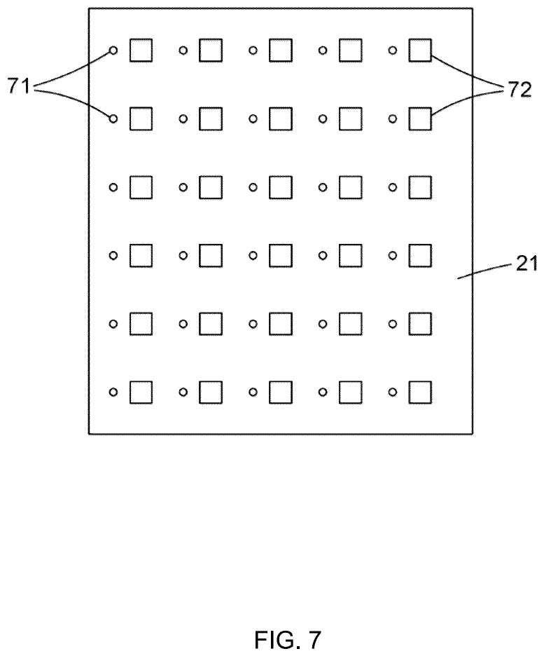

As an alternative, or addition to, measuring the strain as described in FIG. 6 a series of thermocouples and thermopads may be used as described below. The top plate should preferably remain isothermic i.e. the same temperature throughout as different temperatures will induce strain and potentially warping. FIG. 7 depicts an arrangement in which there are a plurality of thermocouples 71 attached to the top plate 21. In the arrangement depicted in FIG. 7 the thermocouples are arranged as an array but they may be arranged any way. The thermocouples measure the temperature of the top plate at the respective position. There are also a plurality of thermopads 72 also attached to the top plate. FIG. 7 depicts these in an array but again, they may take any arrangement.

The thermocouples 71 measure the temperature at a particular position and if the position is at a lower temperature than other positions a nearby thermopad 72 may heat the area so that it the top plate remains isothermic. Even if the overall temperature of the top plate is to be reduced it is important that the top plate as a whole remains isothermic. As such the thermocouples can measure a range of temperatures. The temperature at different positions is measured and compared to ensure that the temperature at each point is the same. The temperature at different positions should be within 0.5° C., and preferably within 0.1° C. Different thermopads can be operated so that the temperature remains constant across the top plate.

FIG. 7 depicts each thermocouple having a corresponding, adjacent thermopad. However, there may not be a one to one ratio: there may be more thermocouples, or more thermopads.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1.-18. (canceled)

19. A system comprising:
a module of an array of quantum computing modules;
a top plate; and
a plurality of supports for the module of the array of quantum computing modules,
wherein a support of the plurality of supports comprises a proximal end and a distal end, and
wherein the proximal end of the support is attached to the top plate and the distal end of the support is attached to the module of the array of quantum computing modules.

20. The system of claim 19, wherein the proximal end of the support, the distal end of the support, or both are attached by a conformal affixent.

21. The system of claim 20, wherein the conformal affixent comprises a ceramic cement.

22. The system of claim 21, wherein the ceramic cement comprises magnesium oxide.

23. The system of claim 20, wherein the conformal affixent comprises a thickness of less than about 200 microns (μm).

24. The system of claim 23, wherein the conformal affixent comprises a thickness of less than about 50 μm.

25. The system of claim 20, wherein a difference in a coefficient of thermal expansion between the top plate and the conformal affixent is less than about 4 parts per million per Kelvin (ppm/K).

26. The system of claim 19, wherein the top plate, the support of the plurality of supports, or both have a coefficient of thermal expansion of less than about 8 ppm/K.

27. The system of claim 26, wherein a difference in the coefficient of thermal expansion between the top plate and the support is less than about 4 ppm/K.

28. The system of claim 19, wherein the top plate comprises molybdenum, copper, or titanium.

29. The system of claim 19, wherein the array of quantum computing modules is configured to transfer a plurality of ions among the modules of the array of quantum computing modules.

30. The system of claim 19, further comprising at least one joist supporting a perimeter of the module of the array of quantum computing modules.

31. The system of claim 30, wherein a joist comprises one or more arches configured to enable a passage of an ion between two adjacent modules of the array of quantum computing modules supported by the joist.

32. The system of claim 19, wherein a surface of the top plate, a surface of the array of quantum computing modules, or both has a flatness of less than about 10 μm.

33. The system of claim 19, wherein a surface of the top plate, a surface of the array of quantum computing modules, or both has a flatness of less than about 2 μm.

34. The system of claim 19, further comprising at least one thermocouple and at least one thermopad configured to measure and adjust a temperature of a portion of the array of quantum computing modules.

35. The system of claim 19, wherein a support of the plurality of supports comprises molybdenum.

36. The system of claim 19, wherein no module of the array of quantum computing modules is connected to an actuator configured to align the module with a neighboring module.

37. The system of claim 19, wherein the module of the array of quantum computing modules comprises at least about 4,096 gate zones.

38. The system of claim 19, further comprising a digital to analog converter (DAC) configured to trap an ion above a surface of the module, wherein the surface of the module is on a side of the module opposite to the distal end of the support attached to the module.
